(19) United States
(12) Patent Application Publication
(10) Pub. No.: US 2026/0251407 A1
(43) Pub. Date: Aug. 27, 2026

(54) Heat Exchanger That Has A Mechanical Connection Between The Tank And The Base

(71) Applicant: MAHLE International GmbH, Stuttgart (DE)

(72) Inventor: Mark SCHIENEMANN, Remseck (DE)

(21) Appl. No.: 19/544,533

(22) Filed: Feb. 19, 2026

(30) Foreign Application Priority Data
Feb. 27, 2025 (DE) 102025107558.1

(51) Int. Cl. F28F 9/16; F28F 1/02

(52) U.S. Cl. CPC F28F 9/165; F28F 1/02; F28F 2230/00; F28F 2275/122

(57) ABSTRACT

A heat exchanger for a motor vehicle is provided. This heat exchanger contains numerous flat tubes through which a first medium flows and around which a second medium flows, such that the two media exchange heat, at least one tank, at least one base, and a seal placed between the tank and the base, wherein the at least one tank has a flange, the at least one base has a circumferential rim, the rim and flange are mechanically connected to one another, and the at least one base has elongated holes for the ends of the tubes. An inner surface of the flange bears at least in part on two narrow sides of the holes, wherein the seal bears at least in part on the two narrow sides of the holes. The rim and the flange are mechanically connected to one another, preferably by means of crimping or folding.

### CROSS-REFERENCE TO RELATED APPLICATIONS

This application claims priority from German Patent Application No. DE 102025107558.1, filed on Feb. 27, 2025, the entirety of which is hereby incorporated by reference herein.

The present invention relates to a heat exchanger for a motor vehicle that has a mechanical connection between the tank and the base according to the independent Numbered Paragraph. The invention also relates to a use of this heat exchanger for a motor vehicle according to the coordinate independent Numbered Paragraph.

DE 37 32 964 A1 discloses a mechanical connection (clamping connection) between a tank with at least one flange and a heat exchanger with a base that has a flexible rim, between which there is a seal (compressed elastic seal), in which the rim is parallel to the outer shape of the flange prior to deformation, and after deformation has slightly wrinkled parts above the flange of the tank, and other parts that remains smooth, parallel to the outer shape of the flange, to obtain the mechanical connection, such that the deformed parts on top of the flange or flanges on the tank form the (form fitting) connection, in which the lower edge of the deformed parts bear firmly on the upper surface(s) of the flange(s), and in which these flexible first parts are cut, parallel to and at a spacing to an outer edge at the height of the upper edge(s) of the flange(s), to minimize the deformation, and to obtain a tight connection, even with large production tolerances, it is proposed that an angled surface be applied to the upper side of the flange or flanges on the plastic water tank, at least near the deformed first parts, wherein this angled surface is slanted toward the outer edge of the flange, and the lower edge of the deformed first parts is folded over this angled surface. There are holes in the base for the ends of flat tubes. The seal fits into a U-shaped rim (outer rim) of the base with the flange on the tank. The U-shaped rim of the base has two side walls. The flange and the seal bear on the inner side wall, unfortunately expanding the connection between the base and the tank along the length of the heat exchanger, increasing the space necessary for the mechanical connection. This inner side wall also lengthens the heat exchanger. Because the available space for the heat exchanger is limited along its length, the two side walls of the U-shaped rim shorten the flat tubes, thus having a negative impact on the performance of the heat exchanger.

The object of the present invention is to reduce the space occupied by the connection between the base and the tank in the heat exchanger, improve the performance of the heat exchanger, and make it easier to produce.

The invention results in a heat exchanger for a motor vehicle, in which heat is exchanged between two media. The heat exchanger contains numerous flat tubes through which a first medium flows and around which a second medium flows, such that the two media exchange heat. The flat tubes are connected to at least two reservoirs for the first medium. The flat tubes are spaced apart in at least one row. Corrugated fins can be placed between the tubes to increase the surface area available for exchanging heat. This heat exchanger has a length, width and height. The length, width and height are substantially orthogonal to one another. The length is substantially aligned with the length of the vehicle, which is the direction in which the vehicle travels. The width of the heat exchanger is substantially aligned with the width of the vehicle. The longer sides of the flat tubes are substantially aligned with the length of the heat exchanger. The shorter sides are aligned with the width of the heat exchanger, and the tubes are placed in at least one row along the width. The heat exchanger can contain numerous rows of flat tubes. These can be placed next to one another along the length. The tubes extend along the height of the heat exchanger.

The tubes can contain numerous channels or chambers for the first medium. The tubes and fins are made of a first metal. They can both be made of an aluminum alloy. The tubes can be formed in an extrusion process. The heat exchanger has at least one base. This base has numerous elongated holes for the ends of the tubes. The base can also be made of the first metal. The at least one base can conceivably be made of an aluminum alloy. The tubes, fins and base are bonded to one another. They can be bonded together by brazing. The at least one tank is made of a second material. This second material is preferably a plastic, mainly made of macromolecules. The second material could also be a metal.

The first medium can be a refrigerant such as propane (R290), carbon dioxide (R744), or R134yf. The first medium could also be a coolant, e.g. a mixture of water and glycol. The second medium can be the air outside the vehicle. The first medium can be heated or cooled by the second. The first medium could also heat or cool the second. The heat exchanger obtained with the invention can be an evaporator, condenser, or radiator. The heat exchanger can contain at least one seal. The seal is a workpiece that prevents, or at least reduces to a negligible amount, the unintended passage of the first medium through the connection between the base and the tank. The seal can be elastic, and can also become deformed when forces are applied to it (and regain its original shape when the forces are removed). The sealing effect is obtained by compressing the seal when creating the mechanical connection between the base and the tank, and when subjected to the pressure of the first medium. The seal can have a substantially circular cross section prior to assembly of the heat exchanger. The seal can have a substantially rectangular shape with tabs on the corners that facilitate assembly of the heat exchanger. A mechanical connection is formed between two workpieces, and can be permanent or releasable. A mechanical connection is obtained by permanently shaping at least one of the three workpieces or by adding at least one additional workpiece. By way of example, a clamp connection or crimp connection is a mechanical connection obtained between two workpieces by a frictional bond, when they are tightened against one another. The body of the motor vehicle determines the amount of space available for the heat exchanger. This installation space must be able to accommodate the components and systems necessary for operating the vehicle.

“Substantially” is understood to mean an angular deviation of ±10°, and a length deviation of ±1 mm. “Approximately” is understood to mean a tolerance of ±10%. A flange is an edge protruding at a substantially right angle, for connecting two components that are flush to one another (lying in the same plane). A mechanical connection is a weight-bearing connection between two components, which can be permanent or releasable. This connection can be a form-fitting and/or frictional connection.

The invention results in a heat exchanger intended for a motor vehicle. This heat exchanger contains numerous flat tubes through which a first medium flows and around which a second medium flows such that the two media can exchange heat, at least one tank, at least one base, a seal placed between the tank and the base, wherein the tank has a flange, the base has a circumferential rim, the rim and the flange are mechanically connected to one another, and the at least one base has elongated holes for the ends of the flat tubes. These holes each have raised circumferential collars. The two long sides extend substantially along the width. An inner surface on the flange bears at least partially on the two narrow sides of the holes, and the seal bears at least in part on the two narrow sides of the holes. The inner surfaces of the flanges bear at least in part on the narrow sides of the holes and are thus supported on the holes, and the seal bears at least in part on the narrow sides of the holes and is thus supported on the holes. This advantageously reduces the length of the connection between the base and the tank in the heat exchanger. Consequently, the heat exchanger occupies less space, or a heat exchanger of the same size is more effective, due to the longer flat tubes. Furthermore, it is less difficult to produce the heat exchanger, because there is no inner support for the flange and the seal on the rim, which also reduces material consumption.

The seal bears on the lower surface of the flange, the circumferential rim, part of the base, and at least in part on the two narrow sides of the holes after the mechanical connection between the base and the tank has been obtained. The seal is therefore supported on the lower surface of the flange, the circumferential rim, part of the base, and at least in part on the narrow sides of the holes. Because the space for the seal between the base and tank is smaller than the seal prior to assembling the heat exchanger, the seal is compressed. This seals the connection between the base and the tank in a plane. The seal preferably bears on almost the entirety of the narrow sides of the holes. This forms an uninterrupted seal in the connection between the base and the tank.

The at least one base preferably has a groove for the seal over at least part of its circumference. The depth of the groove is smaller than the seal. This groove is incomplete on the inside. Consequently, the seal bears at least in part on the narrow sides of the holes and is supported thereon. This advantageously further reduces the length of the connection between the base and tank in the disclosed heat exchanger. The groove can form a recess in the base. The at least one base ideally has a circumferential groove for the seal.

The at least one base can have at least two beads between the holes, such that the seal bears at least in part on these beads. These beads can be on opposite ends of the holes and border on the groove between holes. There can therefore be two beads between the holes on both sides of the at least one base. This results in an uninterrupted seal in the connection between the base and the tank, because the seal bears at least in part on the at least two beads. The uninterrupted seal in the connection between the base and the tank is in a single plane. The sealing effect is improved by the at least two beads. Moreover, the seal is prevented from slipping out and/or becoming deformed toward the interior of the base during and after production of the mechanical connection between the base and the tank. The potential for deformation of the seal is reduced or prevented by the two beads. This results in a reliable seal in the connection between the base and the tank. The beads can conceivably be formed by ridges on the base.

The heat exchanger can contain two bases and two tanks, each of which are mechanically connected to one another. The rim can be flexible, such that it is parallel to the outer contour of the flange before deformation, and first parts thereof become wrinkled after deformation to obtain the mechanical connection, and other parts retain their shape, parallel to the outer shape of the flange, wherein the wrinkled parts on top of the flange can form the mechanical connection in which a lower edge of these wrinkled parts bears tightly on the upper surface of the flange, and the wrinkled parts can be cut, parallel to and at a distance to an outer edge at substantially the same height as the upper edge of the flange, to reduce the wrinkling. This forms a clamping connection between the base and the tank, which can advantageously be made of different materials. By way of example, the base can be made of metal, and the tank can be made of plastic. This results in an simple and inexpensive means for producing the heat exchanger obtained with the invention.

The rim can also have numerous elongated holes that are parallel to the flange, and the parts that remain flat can be between these holes, such that a lower edge of these holes can be pulled over the flange. This further simplifies production.

The upper surface of the flange on the tank can also be angled where the rim is deformed, slanting away from the outer edge of the flange, such that the lower edges of the deformed parts can be pulled over this angled surface. This results in a sealed mechanical connection between the base and the tank if there are large production tolerances.

The heat exchanger can also have two bases and two tanks that mechanically connected to one another. There are numerous, preferably rectangular, lugs on the upper surface of the rim, which can engage behind the flange after producing the mechanical connection, and which can preferably be bent over. The flange on the base preferably has a continuous outer surface on which the inner surface of the upper rim bears. The flange can preferably have T-shaped grooves corresponding to the lugs on the rim. Instead of rectangular, the lugs could also be T-shaped.

This results in a snap-in or crimped connection between the base and the tank. This results in a simple and inexpensive production process.

The flange can also have numerous cutouts for the ends of the flat tubes, once the heat exchanger has been assembled. These cutouts can form grooves. There must always be enough space between the ends of the tubes, the flange, and the base to prevent the ends from reaching the flange. Furthermore, this spacing prevents an undesired bond from forming between the ends of the tubes and the flange after the base has been bonded to the tubes. This spacing can be substantially vertical. The cutouts in the flange maintain the spacing between ends of the tubes and the flange, even though the height of the connection between the base and the tank is reduced. This reduces the height of the heat exchanger, thus reducing the space it requires, or increases the length of the tubes for a heat exchanger of the same size, thus improving its performance.

The flange on the at least one base can also have numerous bevels that border on the ends of the tubes. These bevels can be angled surfaces. There must always be enough space between the ends of the tubes, the flange, and the base to keep the ends from reaching the flange. Furthermore, this spacing prevents an undesired bond from forming between the ends of the tubes and the flange after the base has been bonded to the tubes. This spacing can be substantially vertical. The bevels in the flange maintain the spacing between the ends of the tubes and the flange, even though the height of the connection between the base and the tank is reduced. This reduces the height of the heat exchanger, thus reducing the space it requires, or increases the length of the tubes for a heat exchanger of the same size, thus improving its performance.

The groove for the seal can end on the inner surface below the holes, and this groove is preferably less than approximately 1 mm deep. This depth is substantially vertical. “Approximately” is understood to refer to production tolerances. This results in a compact design for the connection between the base and the tank.

The invention provides that the space for the seal formed by the base, the groove, preferably the beads, the lower surface of the flange, and the two narrow sides of the holes has at least one interrupted wall. This prevents a disadvantageous U-shaped formation of the groove. Consequently, a compact connection can be formed between the base and tank.

There can preferably be a separating wall between the holes on which the seal at least partially bears. This divides the space between the base and the tank into isolated chambers. These can be used to vertically redirect the flow of the first medium through the heat exchanger, or divide the flow path for the first medium in the heat exchanger into numerous flow paths. In addition, an uninterrupted seal can be obtained in the connection between the base and the tank, because the seal can at least partially bear on the separating wall. This continuous seal in the connection between the base and the tank can be in a single plane. The at least two beads further improve this seal. The separating wall can also prevent the seal from slipping and/or becoming deformed toward the interior of the base during and after production of the mechanical connection between the base and the tank. This deformation of the seal is prevented or at least reduced by its bearing on the at least one separating wall. The area between the at least one separating wall and the adjacent hole can remain free of beads.

The seal preferably has a cross section of less than 3 mm. The cross section can be substantially circular prior to connecting the base to the tank. This results in a compact connection.

The ends of the tubes should not extend more than 3 mm past the holes, preferably no more than 2 mm. The tubes extend substantially vertically past the holes. This prevents liquid brazing material from entering the tubes when the base is brazed to the tubes.

The thickness of the base at the upper end of the holes should be at least 35% of the maximum thickness of the base, preferably 40%, and ideally 80%. This allows for a very short groove. Consequently, the length of the connection between the base and the tank can be made even smaller. The thickness is defined by the distance between the inner and outer surfaces of the base at a specific point.

The distance between the holes and the flange on the tank can approach zero. This further reduces the length of the connection between the base and the tank.

There can preferably be corrugated fins between the flat tubes to increase the surface area available for heat exchange between the two media.

The flat tubes, fins and base can preferably be made of a first metal, ideally an aluminum alloy.

The tank can preferably be made of plastic. This results in a simple production of the heat exchanger obtained with the invention.

A cooling module for a motor vehicle obtained with the invention contains at least one heat exchanger connected to a coolant circuit or refrigerant circuit, an air path in which the at least one heat exchanger is located, a fan designed to generate an airflow in the air path, and a frame for the at least one heat exchanger and the fan. The motor vehicle has a length substantially coinciding with the direction in which it travels. As a result of the at least partial bearing of the flange and seal on the narrow sides of the holes in the base for the heat exchanger, the length of the connection between the base and the tank over the length of the motor vehicle is shortened. This either reduces the necessary space for the cooling module, or results in a more powerful heat exchanger of the same size by increasing the lengths of the tubes. Air, forming the second medium, can flow around these tubes. The cooling module has an external fan that propels a rotating impeller in the frame, thus generating an airflow within the air path. This conveys air through the at least one heat exchanger. The frame can also support the at least one other heat exchanger. The frame can have at least one opening in the air path for the impeller. The frame contains the at least one heat exchanger and the fan. The frame is attached to the body of the motor vehicle.

The cooling module can contain at least one heat exchanger obtained with the invention, and at least one other heat exchanger. The at least one other heat exchanger can be placed in front of or behind the at least one heat exchanger obtained with the invention in the air path. The at least one other heat exchanger can contain numerous flat tubes through which another medium can flow, and around which air can flow, such that the two media can exchange heat. The length of the connection between the base and the tank over the length of the vehicle is shortened by the at least partial bearing of the flange and the seal on the narrow sides of the holes in the base of the heat exchanger obtained with the invention. This either reduces the space occupied by the cooling module, or results in a more powerful heat exchanger of the same size as a result of the longer flat tubes. The at least one heat exchanger and the other heat exchanger can each be coolers or condensers to cool different media such as oil and water.

Further details and advantages of the invention can be derived from the following descriptions of exemplary embodiments in conjunction with the drawings. Therein, schematically:

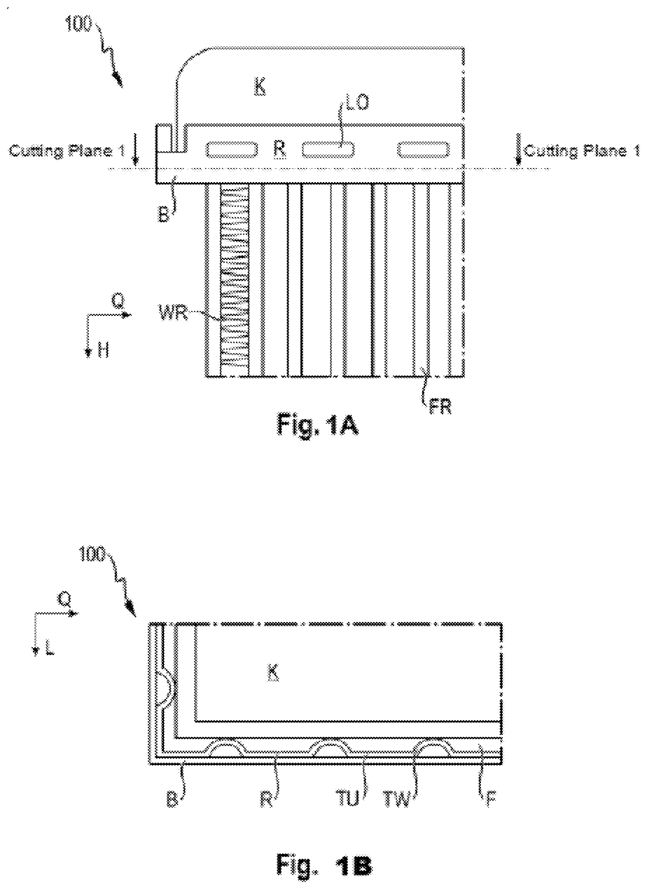

FIG. 1A shows a first view of a heat exchanger obtained with the invention;

FIG. 1B shows a second view of the heat exchanger of FIG. 1A, which is a cross-sectional view of Cutting Plane 1 of FIG. 1A;

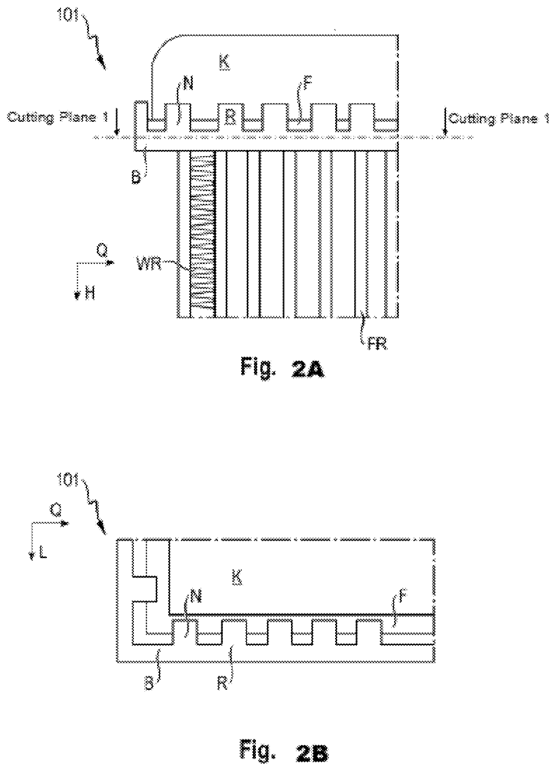

FIG. 2A shows a first view of a second embodiment of the heat exchanger;

FIG. 2B shows a second view of heat exchanger of FIG. 2A, which is a cross-sectional view of Cutting Plane 1 of FIG. 2A;

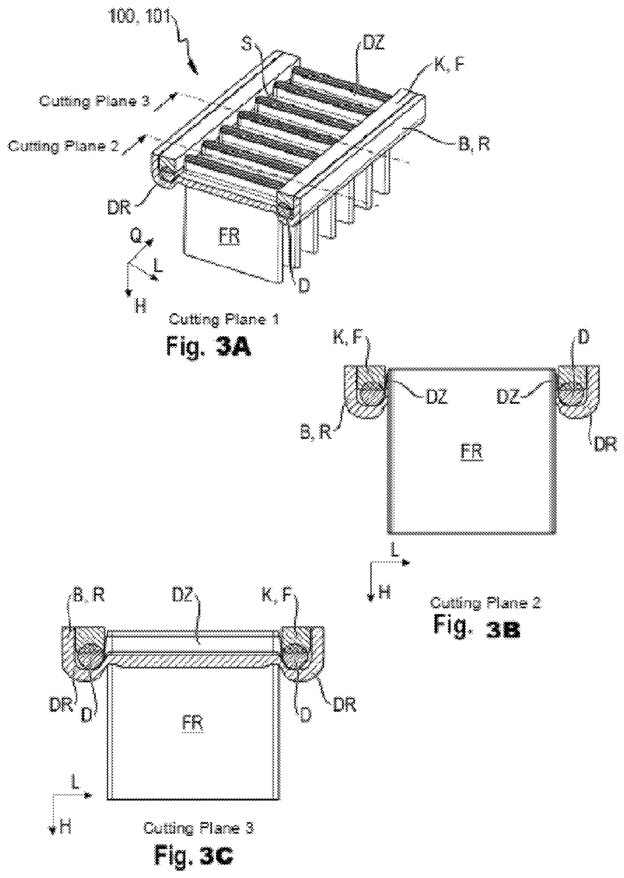

FIG. 3A shows a top perspective view of the heat exchanger;

FIG. 3B shows a second view of the heat exchanger of FIG. 3A, which is a cross-sectional view of Cutting Plane 2 of FIG. 3A;

FIG. 3C shows a third view of the heat exchanger of FIG. 3A, which is a cross-sectional view of Cutting Plane 3 of FIG. 3A;

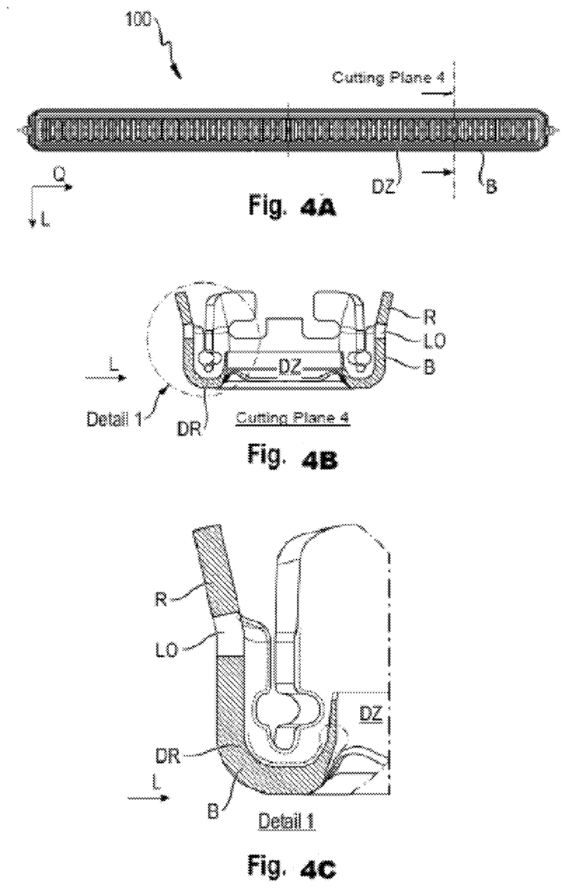

FIG. 4A shows a first view of the base of a heat exchanger from above;

FIG. 4B shows a second view of the base of the heat exchanger, which is a cross-sectional view of Cutting Plane 4 of FIG. 4A; and

FIG. 4C shows a detail view of the base of the heat exchanger depicted in FIG. 4A.

FIGS. 1A and 1B show two partial illustrations of a first embodiment of the heat exchanger 100, from the front and from above. The heat exchanger is shown partially assembled after creating the mechanical connection. The heat exchanger 100 for a motor vehicle can be used in a cooling module, connected to a refrigerant circuit or coolant circuit. The heat exchanger 100 has a length L, width Q, and height H, which are substantially orthogonal to one another. The length L of the heat exchanger 100 is substantially aligned with the length of the vehicle, not shown, which corresponds to the direction in which the vehicle travels. The width Q is aligned with the width of the vehicle. The heat exchanger 100 contains numerous flat tubes FR through which a first medium flows and around which a second medium flows, neither of which are shown, such that the two media exchange heat, a tank K, a base B, and a seal, not shown, between the tank K and the base B. The connection between the tank K and base B is sealed by this seal. The tank K has a flange and the base B has a circumferential rim R. The rim R and flange F are connected to one another mechanically. There are corrugated fins WR between all of the tubes FR. The rim R is flexible and parallel to the outer shape of the flange prior to producing the mechanical connection. First parts TW of the rim R become wrinkled after its deformation, while second parts TU remain parallel to the outer shape of the flange.

The deformed first parts TW on top of the flange F form the mechanical connection where the lower edges of the first parts TW bear tightly on the upper surface of the flange F. These first parts TW can be cut parallel to and at a distance to an outer edge at substantially the height of the upper edge of the flange F to make the rim more flexible. The rim R has numerous elongated holes LO parallel to the flange F, and the second parts TU are between these holes. The lower edges of the elongated holes LO are folded over the flange F. The base B, tubes FR and fins WR are made of metal, preferably an aluminum alloy, and materially bonded to one another. The tank K is made of plastic. The mechanical connection between the base B and the tank K is obtained by clamping. Furthermore, this connection is sealed with a seal, not shown, which is compressed between the base B and the tank K. The space formed by the base B and the tank K is sealed off from the exterior. This results in a simple and inexpensive production. The flange F on the base B has numerous bevels bordering on the ends of the tubes.

FIG. 1A shows a partial illustration of the heat exchanger 100 from the front. FIG. 1A shows the first cutting plane 1, and the heat exchanger 100 is cut along this plane near the base B, which is substantially parallel to the width Q and the length L.

FIG. 1B shows a partial illustration of the heat exchanger 100 from above.

FIGS. 2A and 2B show two partial illustrations of a first embodiment of the heat exchanger 101, from the front and from above. The heat exchanger is shown partially assembled, after creating the mechanical connection. The heat exchanger 101 for a motor vehicle can be used in a cooling module, connected to a refrigerant circuit or coolant circuit. The heat exchanger 101 has a length L, width Q, and height H. The length L, width Q, and height H are substantially orthogonal. The length L of the heat exchanger 101 is substantially aligned with the length L of the vehicle, not shown, which corresponds to the direction in which the vehicle travels. The width Q of the heat exchanger is substantially aligned with the width of the vehicle. The heat exchanger 100 has numerous flat tubes FR through which a first medium flows and around which a second medium flows, neither of which are shown, such that the two media can exchange heat, a tank K, a base B, and a seal, not shown, between the tank K and the base B. The tank K has a flange and the base B has a circumferential rim R. The rim R and flange F are mechanically connected to one another. There are corrugated fins WR between each of the tubes FR. There are a number of flexible rectangular lugs N on the top of the rim R. These lugs N engage, at least in part, behind the flange F, where they are bent over. The base B, tubes FR, and fins WR are made of metal, preferably an aluminum alloy, and are materially bonded to one another, preferably by brazing. The tank K is made of plastic. The mechanical connection between the base B and the tank K is a snap-on or crimped connection between two different materials. This connection is sealed by a seal, not shown, that is compressed within the connection. The space formed by the base B and the tank K is sealed off from the exterior. This results in a simple and inexpensive production. The flange F has numerous cutouts for the ends of the tubes (not shown).

FIG. 2B shows a partial illustration of the heat exchanger 101 from the front. The first cutting plane 1 is shown in FIG. 1A, and the heat exchanger is cut along this plane near the base B, which is substantially parallel to the width Q and the length L.

FIG. 2B shows a partial illustration of the heat exchanger 101 from above.

FIGS. 3A-3C shows three sectional views of the tank K and base B for the heat exchanger 100, 101. The heat exchanger 100, 101 has a length L, width Q, and height H. The length L, width Q, and height H are substantially parallel to one another. The base B is shown in part with the rim R. The tank K is shown in part with the flange F. Part of the seal D is also shown. The base B has elongated holes DZ for the ends of the flat tubes FR. These ends of the tubes FR are bonded to the holes DZ. The holes DZ have raised circumferential collars extending toward the tank K. The holes DZ are substantially rectangular, with two long sides and two short sides. The long sides extend substantially along the width Q. There are two beads S between each of the holes DZ. The seal D is between the base B and the tank K. The seal D is elastic and can be made of plastic. The connection between the base B and the tank K is sealed by the seal. The cross section of the seal D is less than 3 mm, and substantially round prior to obtaining the connection. This seal D has a substantially rectangular shape, with tabs on the corners (not shown). The seal D lies at least in part on the holes DZ and the beads S. The base B has a circumferential groove DR for the seal D. The groove DR ends vertically below the holes DZ. The groove DR forms a recess. The groove DR is preferably less than 1 mm deep. This results in a vertically compact connection. This also results in an uninterrupted seal between with the base and the tank, because the seal D lies at least in part on the holes DZ and the beads S. This uninterrupted seal lies in a plane. The beads D also prevent the seal D from slipping and/or becoming deformed toward the interior of the base B during or after producing the mechanical connection between the base B and the tank K. The flange F has an inner surface.

FIG. 3A shows the base B and tank K cut along the first cutting plane 1, as well as part of a tube FR. The two narrow sides of the holes DZ are adjacent to an inner surface of the flange F, and the seal D bears on the two narrow sides of the holes DZ. The inner surfaces of the flange F bear on the narrow sides of the holes DZ and are supported thereon, and the seal D also bears on these narrow sides and is supported thereon. This advantageously shortens the connection between the base and the tank. There are two beads S between the holes DZ adjacent to the groove DR, forming ridges. These beads S prevent the seal D from slipping or becoming deformed toward the interior of the tank. The seal D bears, at least in part, on the lower surface of the flange F, the circumferential rim R, the groove DR in the base B, the two narrow sides of the holes DZ, and the beads S, such that it is supported thereon. Because the space for the seal D between the base B and tank K is smaller than the seal D prior to assembling the heat exchanger, the seal is compressed. This results in an uninterrupted seal between the base B and the tank K in a single plane. The second cutting plane 2 is parallel to the length L, and passes through the middle of a hole DZ and a tube FR. The third cutting plane 3 is parallel to the length L, and passes through the middle of the space between two holes DZ.

FIG. 3B shows the second cutting plane 2, passing through the middle of a hole DZ, parallel to the length L.

FIG. 3C shows the second cutting plane 2, passing through the middle of the space between two holes DZ, parallel to the length L.

FIGS. 4A-4C show the base B, the cutting plane 4 through the base B, and another detail of the base B of the first embodiment of the heat exchanger 100 obtained with the invention, from above. The heat exchanger 100 has a length L, width Q, and height H.

FIG. 4A shows the based B from above. The base B has a substantially rectangular shape. The base B has numerous elongated holes DZ. This illustration shows the fourth cutting plane, which passes through the middle of a hole, parallel to the length L.

FIG. 4B shows the fourth cutting plane 4 passing through the base B with the hole DZ. The hole DZ has a raised circumferential collar. The base B has a groove DR and the raised rim R. The rim R has elongated holes LO. The first detail D1 shows the groove in detail.

FIG. 4C shows the first detail 1 of the base B and the hole DZ. The first detail 1 shows the shape of the groove DR for the seal, not shown, and the rim R with an elongated hole LO. The thickness of the base B at the upper end of the hole DZ is at least 35% of the maximum thickness of the base B. This can also be 40%, or preferably 80%. This results in a groove DZ that extends only slightly along the length L. Consequently, the connection between the base and tank can be shortened even more. The thickness is the distance between the inner and outer surfaces at a specific point on the base B. The specification can be readily understood with reference to the following Numbered Paragraphs:

Numbered Paragraph 1. A heat exchanger (100, 101) for a motor vehicle, containing:
numerous flat tubes (FR) through which a first medium (M1) flows and around which a second medium (M2) flows, such that the two media exchange heat,
at least one tank (K),
at least one base (B), and
a seal (D) is placed between the tank (K) and the base (B), wherein
the at least one tank (K) has a flange (F),
the at least one base (B) has a circumferential rim (R)
the rim (R) and flange (F) are mechanically connected to one another, and
the at least one base (B) has elongated holes (DZ) for the ends of the tubes (FR),
characterized in that an inner surface of the flange (F) bears at least in part on two narrow sides of the holes (DZ), wherein the seal (D) bears at least in part on the two narrow sides of the holes (DZ).

Numbered Paragraph 2. The heat exchanger (100, 101) according to Numbered Paragraph 1, characterized in that the at least one base (B) has an at least partially circumferential groove (DR) for the seal (D).

Numbered Paragraph 3. The heat exchanger (100, 101) according to Numbered Paragraph 1 or 2, characterized in that the at least one base (B) has at least two beads(S) between the holes (DZ), wherein the seal (D) at least partially bears on these beads(S).

Numbered Paragraph 4. The heat exchanger (100) according to Numbered Paragraph 1, 2, or 3, characterized in that the rim (R) is flexible, wherein
the rim (R) is parallel to the outer shape of the flange (F) prior to deformation,
first parts (TW) of the rim (R) become wrinkled when producing the mechanical connection, and second parts (TU) remain parallel to the outer shape of the flange (F),
the first parts (TW) above the flange (F) form the mechanical connection, in which a lower edge of these parts (TW) bears tightly against the upper surface of the flange (F), and
the flexible first parts (TW) are cut parallel to and at a distance to the outer edge of the flange (F) at substantially the height of the upper edge thereof to make the rim more flexible.

Numbered Paragraph 5. The heat exchanger (100) according to Numbered Paragraph 4, characterized in that the rim (R) has numerous elongated holes (LO) parallel to the flange (F), wherein the second parts (TU) of the rim (R) are between these holes (LO), and a lower edge of each hole (LO) is folded over the flange (F).

Numbered Paragraph 6. The heat exchanger (101) according to Numbered Paragraph 1, 2, or 3, characterized in that there are numerous lugs (N) on the top of the rim (R), which are preferably rectangular, wherein
these lugs (N) engage in part behind the flange (F) after producing the mechanical connection, and
these lugs (N) are preferably bent over.

Numbered Paragraph 7. The heat exchanger (100, 101) according to Numbered Paragraph 1, 2, 3, 4, 5, or 6, characterized in that the flange (F) has numerous cutouts (AB) for the ends of the tubes (FR) when the heat exchanger (100) has been assembled.

Numbered Paragraph 8. The heat exchanger (100, 101) according to Numbered Paragraph 1, 2, 3, 4, 5, or 6, characterized in that the flange (F) has numerous bevels (FA) that are adjacent to the ends of the tubes (FR).

Numbered Paragraph 9. The heat exchanger (100, 101) according to Numbered Paragraph 1, 2, 3, 4, 5, 6, 7 or 8, characterized in that the groove (DR) ends on the inner surface below the holes (DZ), and is preferably less than 1 mm deep.

Numbered Paragraph 10. The heat exchanger (100, 101) according to Numbered Paragraph 1, 2, 3, 4, 5, 6, 7, 8, or 9, characterized in that a space for the seal (D) formed by the base (B), groove (DR), preferably the beads(S), the lower surface of the flange (F), and two narrow sides of the holes (DZ) has at least one interrupted wall.

Numbered Paragraph 11. The heat exchanger (100, 101) according to any of the preceding Numbered Paragraphs, characterized in that there is at least one separating wall (W) between the holes (DZ), and the seal (D) preferably bears at least in part on this wall (W).

Numbered Paragraph 12. The heat exchanger (100, 101) according to any of the preceding Numbered Paragraphs, characterized in that the seal (D) has a cross section of less than 3 mm.

Numbered Paragraph 13. The heat exchanger (100, 101) according to any of the preceding Numbered Paragraphs, characterized in that the ends of the tubes (FR) extend beyond the holes (DZ) less than 3 mm, preferably less than approximately 2 mm.

Numbered Paragraph 14. The heat exchanger (100, 101) according to any of the preceding Numbered Paragraphs, characterized in that the thickness of the base (B) at the upper ends of the holes (D) is at least 35% of the maximum thickness of the base, preferably 40%, and ideally 80%.

Numbered Paragraph 15. A cooling module (200) for a motor vehicle, containing:
at least one heat exchanger (100, 101) according to any of the Numbered Paragraphs 1 to 14, which can be connected to a coolant circuit or a refrigerant circuit,
an air path (201) in which the at least one heat exchanger (100) is located,
a fan (202) for generating an airflow in the air path (201), and
a frame (203) for the at least one heat exchanger (100) and the fan (202).

### List of Reference Symbols

100 first embodiment of the heat exchanger obtained with the invention
101 second embodiment of the heat exchanger obtained with the invention
200 cooling module
201 air path
202 fan
203 frame
M1, M2 first medium, second medium
K tank
B base
D seal between the tank and the base
FR flat tube
WR corrugated fin
R rim
F flange
FA bevels on the flange
AB cutouts on the flange
DZ holes in the base
TW, TU first and second parts of the rim
LO elongated hole in the rim
N lugs
DR partial circumferential groove
S beads between the holes

1-15. (canceled)

16. A heat exchanger for a motor vehicle, comprising:
a plurality of flat tubes through which a first medium flows and around which a second medium flows, such that the two media exchange heat across each of the plurality of flat tubes,
at least one tank,
at least one base, and
a seal is disposed between the tank and the base, wherein
the at least one tank comprises a flange,
the at least one base comprises a circumferential rim
the rim and flange are mechanically connected to one another, and
the at least one base comprises a plurality of elongated holes that establish the ends of the tubes,
wherein an inner surface of the flange bears at least in part on two narrow sides of the holes, wherein the seal bears at least in part on the two narrow sides of the holes.

17. The heat exchanger according to claim 16, wherein the at least one base comprises an at least partially circumferential groove for the seal.

18. The heat exchanger according to claim 16, wherein the at least one base has at least two beads between the holes, wherein the seal at least partially bears on these beads.

19. The heat exchanger according to claim 16, wherein the rim is flexible, wherein
the rim is parallel to an outer shape of the flange prior to deformation,
first parts of the rim establish a wrinkled configuration when producing the mechanical connection, and second parts of the rim remain parallel to the outer shape of the flange,
the first parts of the rim above the flange establish the mechanical connection, in which a lower edge of the respective first parts of the rim bears tightly against the upper surface of the flange, and
the first parts of the rim extend parallel to and at a distance to an outer edge of the flange at substantially a height of the upper edge thereof increasing a flexibility of the rim.

20. The heat exchanger according to claim 19, wherein the rim comprises a plurality of elongated holes parallel to the flange, wherein the second parts of the rim are between these holes, and a lower edge of each hole is folded over the flange.

21. The heat exchanger according to claim 16, further comprising a plurality of lugs disposed on the top of the rim, wherein
the plurality of lugs engage in part behind the flange after producing the mechanical connection, and
the lugs that engage behind the flange are bent over.

22. The heat exchanger according to 16, wherein the flange comprises a plurality of cutouts for the ends of the tubes.

23. The heat exchanger according to claim 16, wherein the flange comprises a plurality of bevels that are adjacent to the ends of the tubes.

24. The heat exchanger according to claim 17, wherein the groove ends on the inner surface of the flange below the holes.

25. The heat exchanger according to claim 16, further comprising a space for the seal formed by the base, groove, wherein a lower surface of the flange, and two narrow sides of the holes have at least one interrupted wall.

26. The heat exchanger according to claim 16, further comprising at least one separating wall between the holes, and the seal bears at least in part on this wall.

27. The heat exchanger according to claim 16, wherein the seal has a cross section of less than 3 mm.

28. The heat exchanger according to claim 16, wherein the ends of the plurality of tubes extend beyond the holes less than 3 mm.

29. The heat exchanger according to claim 16, wherein a thickness of the base at the upper ends of the holes is at least 35% of the maximum thickness of the base.

30. A cooling module for a motor vehicle, comprising:
at least one heat exchanger according to claim 16, which the at least one heat exchanger being configured to be connected to a coolant circuit or a refrigerant circuit,
an air path in which the at least one heat exchanger is located,
a fan for generating an airflow in the air path, and
a frame for the at least one heat exchanger and the fan.

31. The heat exchanger according to claim 21, wherein the plurality of lugs are each rectangular.

32. The heat exchanger according to claim 24, wherein the groove is less than 1 mm deep.

33. The heat exchanger according to claim 25, wherein the space for the seal is additionally formed by beads between each of the holes.

34. The heat exchanger according to claim 28, wherein the ends of the plurality of tubes extend beyond the holes less than approximately 2 mm.

35. The heat exchanger according to claim 29, wherein the thickness of the base at the upper ends of the holes is 80% of the maximum thickness of the base.
